(19) United States
(12) Patent Application Publication
(10) Pub. No.: US 2008/0282455 A1
(43) Pub. Date: Nov. 20, 2008

(54) FLAME RESISTANT AND HEAT PROTECTIVE FLEXIBLE MATERIAL WITH INTUMESCING GUARD PLATES AND METHOD OF MAKING THE SAME

(75) Inventors: Brad Jones, St. Paul, MN (US); Hong Ji, Woodbury, MN (US); Steven Kim, Woodbury, MN (US); Young Hwa Kim, Hudson, WI (US); Young Kwon Kim, Woodbury, MN (US); Soon C. Park, Moreno Valley, CA (US); Clifton F. Richardson, Woodbury, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: HIGHER DIMENSION MATERIALS, INC., OAKDALE, MN (US)

(21) Appl. No.: 12/122,193

(22) Filed: May 16, 2008

Related U.S. Application Data
(60) Provisional application No. 60/938,747, filed on May 18, 2007.

(51) Int. Cl. A62B 17/00

(52) U.S. Cl. 2/458; 2/81

(57) ABSTRACT

A protective material comprising a flexible substrate including a top surface and a plurality of discrete guard plates affixed to the top surface in a spaced relationship to each other. The guard plates comprise a material which significantly expands upon the addition of sufficient heat forming a thermally insulating, flame retardant layer.

### REFERENCE TO RELATED APPLICATION

This application claims the benefit of U.S. provisional application Ser. No. 60/938,747, filed May 18, 2007 and entitled FLAME RESISTANT AND HEAT PROTECTIVE FLEXIBLE MATERIAL WITH INTUMESCING GUARD PLATES AND METHOD OF MAKING THE SAME, which is incorporated herein in its entirety by reference.

### TECHNICAL FIELD

The present invention relates to materials made to protect the wearer from heat and fire. More specifically, the present invention relates to flame retardant flexible materials that provide thermal protection through an intumescence mechanism.

### BACKGROUND

Various forms of protective materials have been advanced and used to form protective garments such as gloves, jackets and the like. In addition to providing protective functions such as cut, puncture, and thermal resistance, the fabric material may also be flame resistant, flexible, durable, and abrasion resistant, and facilitate, improve, or allow the gripping and holding of objects.

Many forms of protective garments have utilized fabrics made from woven or non-woven forms of fibers and yarns. Some commonly used fibers include cellulose (cotton), polyester, nylon, aramid (Kevlar), meta-aromatic polyamide (Nomex), acrylic and Ultra-High Molecular Weight Polyethylene (Spectra). Nevertheless, it is often difficult to achieve all the desired performance characteristics in a protective material for a specific application when only fibers are used to form the protective material. For example, an aramid fabric has high tensile strength and is ballistic resistant, but the fabric is nevertheless weak against abrasion, degrades upon exposure to sunlight, and offers little puncture resistance against sharp, needle-like objects. As another example, fabrics made of nylon are strong and have good abrasion resistance, but the nylon fabric has poor flame retardant properties and low cut resistance against sharp edges as well has poor thermal and chemical (particularly acid) stability. In general, compromises usually have to be made when using a pure fabric, especially in high-performance fabric applications.

A protective material that integrates a flexible substrate with rigid guard plates has been advanced by HDM, Inc. of St. Paul, Minn. and distributed under the trademark SuperFabric®. Generally, this material includes a plurality of guard plates, which are thin and formed of a substance chosen to resist a penetration force equivalent to, or stronger than, that exerted by a cutting force of the level and type for which the material is to be used. In one embodiment, a polymer resin is used as the material forming the guard plates. The resin can be printed on the flexible substrate in a design that forms spaced-apart guard plates. The resin affixes to the flexible substrate and when cured, forms a strong bond therewith. The composite nature of the material assembly makes it possible to realize locally hard, puncture and cut resistant plate features. However, at the same time, the overall material assembly exhibits global conformability due to the flexibility of the substrate and the spaced apart relationship of the guard plates.

Flame retardant SuperFabric® can be made using a guard plate material that is flame retardant. Alternatively or in addition, it is also possible to add a degree of flame retardancy to a flammable fabric by the addition of flame retardant guard plates.

Three different approaches to creating flame resistant polymeric materials from substantially flammable ones have predominate. The first such approach is through the use of halogenated flame retardants. Most commonly, brominated flame retardants are used, although chlorinated flame retardants have also seen significant application. Such additives are capable of reacting with free radicals produced during combustion, removing them from the burning environment and preventing any flame propagation. While generally very efficient, halogenated flame retardants may pose significant environmental and health concerns.

The second approach is through the use of additives which decompose to form inflammable vapors while absorbing heat. An example of such additives is alumina trihydrate (ATH), a compound that decomposes around 200° C. to form alumina and water vapor. This reaction absorbs heat from the contacting flame source and the evolved water vapor suppresses the flame by crowding oxygen away from the surface of the material. Additives like ATH are generally less efficient than other flame retardants and may not be suitable for applications with more stringent fire resistant requirements.

The third approach is through the use of intumescent additives. When these additives are incorporated into a material and the material is subsequently exposed to a flame, a physical or chemical reaction or series of reactions takes place, resulting in an expanded insulating and ignition resistant char or ceramic that shields any material underneath. In many phosphorous-based intumescent systems, closed cell char is formed under intense heat and a blowing agent or leavening agent is included to expand the char. For instance, a common intumescent system used in creating flame resistant thermoplastics and thermosets is a blend of ammonium polyphosphate, pentaerythritol, and melamine powders; depending on the chain length of the ammonium polyphosphate, it decomposes between about 150° C. and about 300° C., ultimately forming phosphoric acid. The phosphoric acid subsequently dehydrates the pentaerythritol, and in some cases also the thermoplastic or thermoset material, causing the formation of char with a closed cell structure. Finally, the melamine decomposes around 300° C., absorbing heat and forming an ample amount of nitrogen gas which expands the char. Other intumescent systems, such as sodium silicate or expandable graphite, utilize blowing agents within individual particles to expand inherently ignition resistant materials. Expandable graphite is produced by intercalating graphite with nitric or sulfuric acid, resulting in acid molecules being held by dispersion forces between the planes of carbon atoms in the crystal structure of graphite. Upon heating, the acid molecules decompose to form gases which force the planes of carbon atoms apart. This process transforms an expandable graphite flake into a “worm” that has expanded in thickness as much as 1000% or more. As graphite is ignition resistant, the expanded flakes create a ceramic barrier protecting underlying material from a flame.

Intumescent systems have been employed in a wide variety of applications, including sealants, coatings and paints, resins, cable jacketing, varnishes, structural materials, textiles, and many other situations where an ignition resistant, insulating, or self-extinguishing polymeric material is required. Fire resistant sealant compositions are described in U.S. Pat. No. 6,747,074. These compositions include a hydrated alkali metal silicate to provide intumescent character, a polymeric thermosetting or thermoplastic binder, and an additional flame retardant to promote charring, such as ammonium polyphosphate. Such sealant compositions can be employed in buildings to prevent the spread of a fire from one room to the next. A description of intumescent coatings is given in U.S. Pat. No. 6,642,284, where melamine polyphosphate is described as a blowing agent in combination with a film-forming polymeric binder, a char-forming agent, and an additional flame retardant material. U.S. Pat. No. 6,228,914 specifies an intumescent resin suitable for coating or impregnation of a substrate material, wherein the resin consists of two intumescent components. The first component is an acid-curable melamine resin binder combined with an acidic phosphorous compound; the hardened binder is capable of char formation upon flame contact. The second component, being bound by the melamine resin, is expandable graphite particles. Compositions appropriate for cable jacketing are described in U.S. Pat. No. 5,475,041, consisting of a polyolefin or olefin copolymer with melamine or melamine salts, a polyphenylene oxide compound, and a silica-based material incorporated as additives. An intumescent material capable of being shaped into boards or sheets is presented in “Intumescent Silicate-based Materials: Mechanism of Swelling in Contact with Fire,” Fire and Materials, Vol. 9, No. 4, pp. 171-175. The material is produced by applying an aqueous solution of sodium silicate to non-woven glass fibers and allowing the sodium silicate solution to dry.

In one embodiment, heat-expandable microspheres or microcapsules are the integral constituent of the intumescent system being applied to fabric. These small, spherical particles are on the order of nanometers to millimeters in diameter and have a core, containing either a volatile liquid or a gas, encapsulated by a polymeric shell. On heating, the core will expand, either as a normal gaseous expansion or by vaporization of a liquid core, providing pressure against the shell wall which simultaneously softens and expands. Commercially available heat-expandable microspheres, such as Expancel® microspheres produced by Expancel, Inc., are capable of expanding up to 40 times their original volume or more. Each microsphere will expand to a maximum point, after which the expanded shell ruptures and the core material is released. For one embodiment of the present invention, the microspheres serve the purpose of providing heat-expanding character while also contributing to the flame resistance of the system.

Heat-expandable and non-expanding microspheres have been employed in applications, in both unexpanded and expanded states. These applications include printing inks and dyes, foam production, controlled drug and herbicide delivery, filler material, thermal insulation material, adhesives, paper, and textiles. In U.S. Pat. No. 4,006,273, a process for adding three-dimensional graphics and effects to fabrics is disclosed. Expandable microspheres are incorporated into a heat-curable polymeric material which is then printed onto the surface of fabric. Upon heating, the microspheres expand, creating a three-dimensional graphic on the fabric, and the polymeric material cures to a hardened state, rendering the creation washable and dry-cleanable. Microspheres have also been used to create chemical resistant fabrics, as in U.S. Pat. No. 4,201,822, which can be incorporated into garments and provide protection to the wearer against toxic agents. Resins are loaded with microspheres consisting of a semi-permeable polymeric shell and a core composed of neutralization or decontaminant compounds, at which point the fabric substrate is coated with the resin and the resin is cured. Upon contact with toxic agents, the semi-permeable polymeric microsphere shell allows the toxic agents to diffuse to the microsphere core, where it is neutralized. U.S. Pat. Nos. 4,898,734, 4,675,189, 5,529,777, and 6,340,653 all pertain to microspheres containing a core substance which can diffuse through the encapsulating shell over time, facilitating a controlled release of the core substance to a desired target. U.S. Pat. Nos. 5,260,343, 6,638,984, and 6,720,361 all describe methods of foam production in which heat-expandable microspheres are used as a primary blowing or co-blowing agent. U.S. Pat. Nos. 6,207,730 and 6,903,898 both apply microspheres in the production of adhesives. For the former patent, microspheres are incorporated into an epoxy adhesive, allowing the adhesive to be applied to the surface of a porous substrate without flowing through the substrate. For the latter patent, microspheres are incorporated into a pressure sensitive adhesive for use as a hard drive label; after application, the label can easily be removed by heating and expanding the microspheres, reducing the bonding strength of the label to the drive surface.

Heat-expandable microspheres have been utilized as active components of intumescent systems for applications requiring flame resistant materials. For example, U.S. Pat. No. 4,719,249 discloses a composition for a flame resistant material to be employed as a fire stop seal along walls and floors. An inherently flame resistant polyorganosiloxane elastomer is combined with heat-expandable microspheres, such that the elastomer can expand upon flame contact to prevent flame propagation throughout different areas of buildings. Another composition suitable for a fire stop seal material is described in U.S. Pat. Nos. 5,132,054 and 5,137,658. In this case, heat-expandable microspheres are combined with an additional intumescent compound, such as expandable graphite or sodium silicate. The microspheres provide low temperature expansion up to 300%, while the additional compound provides ignition resistant character to the material, as well as high temperature expansion up to 700%. An intumescent coating, as disclosed in U.S. Pat. No. 5,786,095, utilizes heat-expandable microspheres in an alkali metal silicate solution combined with a thickening frit material and other optional additives. Again, the coating is inherently flame resistant and the microspheres facilitate expansion of the coating, upon flame contact, to protect the substrate to which it is applied.

Traditionally, there have been two distinct approaches to creating flame resistant fabric material. Naturally, the most successful approach has been to weave a fabric using an inherently flame resistant fiber. Polyaramid or polybenzimidazole fibers, such as commercially available Nomex® or PBI Gold® products, will not ignite or melt at any temperature. On the other hand, these fibers suffer from a number of shortcomings. Polyaramid fabrics are moderately costly to produce, possess poor mechanical strength and thermal insulation, and degrade under exposure to UV light. Polybenzimidazole fabrics are prohibitively expensive to produce and also suffer from poor mechanical strength. Another inherently flame resistant fiber, oxidized polyacrylonitrile, is described in U.S. Pat. Nos. 4,865,906, 6,358,608, and 6,287,686 and commercially available under the name Carbon-X®. Oxidized polyacrylonitrile is an intumescent fiber and is a flame resistant fiber. However, it is costly to produce and suffers from poor mechanical strength, as well as poor feel and breathability.

The other approach has been to apply a chemical treatment to a normally flammable fiber, wherein each fiber of the subsequently woven fabric is coated with a flame resistant or flame retardant material. For example, commercially available Indura® or Proban® fabrics are composed of cotton or a cotton/nylon blend in which the fibers are coated with a chemical that promotes charring behavior. While a cost effective solution, the chemical treatment of such fabrics is not permanent and the flame resistance is enervated with laundering. In addition, the chemical treatment reduces the mechanical strength of the fabric.

### SUMMARY

To achieve fire resistance and thermal insulation in a fabric material while maintaining mechanical strength, flexibility, and breathability, a base fabric is chosen which possesses good mechanical strength, flexibility, and breathability. To impart fire resistance and/or thermal insulation to the base fabric, a repeating pattern of non-overlapping, discontinuous guard plates are affixed to the surface of the fabric. Once affixed, the guard plates are of uniform shape and size with uniform distances of separation, that is, uniform areas of continuous, exposed base fabric.

The guard plates improve the fire resistance and thermal insulation properties of the base fabric. In one simple form, the guard plates are composed of a polymeric material having heat-expandable materials, such as microspheres, incorporated within. Upon intense heat or flame contact, the heat expandable materials expand and, consequently, the affixed guard plates expand. The polymeric material forming the guard plate preferably is inherently flame resistant and has a relatively low thermal conductivity. Once expanded, the affixed guard plates cover the entire base fabric area exposed to flame in an essentially continuous manner, protecting it from flame contact and insulating it from heat. The thermal insulation is enhanced both by the reduction in effective thermal conductivity which results from the expansion of the polymeric material and by the fact that the thickness of the polymeric material will reduce the rise in temperature of the base fabric.

In one embodiment of the invention heat expandable microspheres are used as the intumescing agent. Such microspheres can be constructed of a polymeric shell encapsulating a core of water or a water-based solution with an elevated boiling point. This design has the advantage that the evaporation of the water within the cores of the microspheres not only causes the microspheres, and hence the guard plates, to expand, but it also absorbs a significant amount of heat away from the flame source. Even more beneficially, the polymeric material forming the guard plates can be chosen to have an elongation ability so great that the microspheres can be allowed to expand to their maximum limit. At this level of expansion, the microspheres rupture and their contents are released, adding further to the protection of the base fabric. Alternatively, the microspheres can encapsulate a core of a different non-flammable liquid with an appropriate boiling point to the same effect. Another alterative is to incorporate a gas such as nitrogen in the microsphere which will cause expansion due to the increasing pressure of the gas with increasing temperature and also due to the softening of the polymeric shell with increasing temperature.

Under normal conditions, specifically prior to any intense heat or flame contact, the continuous regions of exposed base fabric surrounding the affixed guard plates allow for the fabric to maintain the flexibility and breathability of the base fabric. In addition, the mechanical properties of the base fabric can be significantly enhanced by the affixation of the fire resistant guard plates. If the base fabric and polymeric material forming the guard plates are chosen to be UV resistant, the total fabric structure will also be UV resistant. The guard plates, being composed of a thermally insulating material, also afford insulating character to the fabric under normal conditions.

In embodiments of the present invention which incorporate heat expandable microspheres encapsulating a fluid which boils, at atmospheric pressure, between 100 C and 400 C, the flame retardant mechanism includes the following. Firstly, the fluid within the cores of the microspheres evaporates, absorbing heat from the flame source. Secondly, the fluid vapor expands the microspheres and, as a result, expands the inherently flame resistant guard plate material, creating an essentially continuous film over the base fabric. Thirdly, the microspheres expand to their maximum limit and rupture, releasing their contents to drive oxygen away from the guard plate surface and quench the flame. Even when non-flame resistant substrates are used, these mechanisms combine to afford flame resistance for a period of time that may even be greater than the 12 seconds required by standard textile flammability tests. When polyester or nylon is chosen as the base substrate, the ultimate failure of the fabric may not be due to ignition, but rather may be due to the melting of the base substrate, because eventually enough heat may transfer through the expanded guard plates, warming the base fabric above its melting temperature. A fabric having flame resistant, insulating, mechanically strong, flexible, breathable, and/or UV resistant properties can be created at considerably less cost than fabrics constructed from inherently flame resistant fibers. This is due to at least three factors. One important factor is that conventional base fabrics can be selected for use at only a fraction of the cost of commercially available flame resistant fabrics like Nomex®, PBI Gold®, and Carbon-X®. In addition, the materials employed in the guard plates can be relatively inexpensive. Furthermore the fact that the guard plates are affixed in a discontinuous manner helps lower the cost. Although the guard plates are affixed so as to maintain flexibility and breathability, the fire resistant material is in effect only being added to a portion of the surface of the base fabric, rather than the entire surface.

In embodiments where the fabric of the present invention is intended to be used in an application where both surfaces may encounter flame contact, the fire resistant guard plates may be affixed to both sides of the base fabric. In other embodiments, the affixation of guard plates to a single side of the fabric will be sufficient, for example, in fire resistant apparel.

An additional benefit of the present invention is the ability to provide cut, pierce, and puncture resistance to the fabric. U.S. Pat. Nos. 5,853,863, 5,906,873, and 6,159,590 and Patent Application 20040192133 disclose a manner in which guard plates are affixed to a base fabric, providing cut, pierce, and puncture resistance. An additional layer of discontinuous guard plates can be affixed to the flame resistant guard plates, creating a fabric with exceptional thermal insulation and cut, pierce, puncture, and flame resistance while maintaining mechanical strength, flexibility, and breathability. Alternatively, the cut, pierce, and puncture resistant guard plates could be affixed initially to the base fabric and the flame resistant guard plates could be affixed to these. Other properties can be incorporated into a conventional base fabric without significantly compromising its desirable properties using this method.

One object of the present invention is to provide a fabric material which is made fire resistant through an intumescent mechanism. The flexible substrate used in the present invention can be any of the fabric materials discussed above and in the background section, or it can be based on standard non-flame retardant materials such as nylon or polyester. This fabric material can be made mechanically strong, thermally insulating, UV resistant, flexible, and breathable. If desired, the fabric assembly can be designed to also possess slash, puncture and/or abrasion resistant properties.

### BRIEF DESCRIPTION OF THE DRAWINGS

FIGS. 1A-1C show various views of an example of a protective material comprising hexagonal plates attached to a flexible substrate.

FIG. 2 shows an example of a protective material comprising square and pentagonal plates with relatively tight gaps attached to a flexible substrate.

FIG. 3 shows an example of a protective material comprising square and pentagonal plates with relatively wide gaps attached to a flexible substrate.

FIG. 4 shows an example of a protective material comprising circular plates attached to a flexible substrate.

FIGS. 5A-5D show an example of a protective material in various stages of intumescing.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

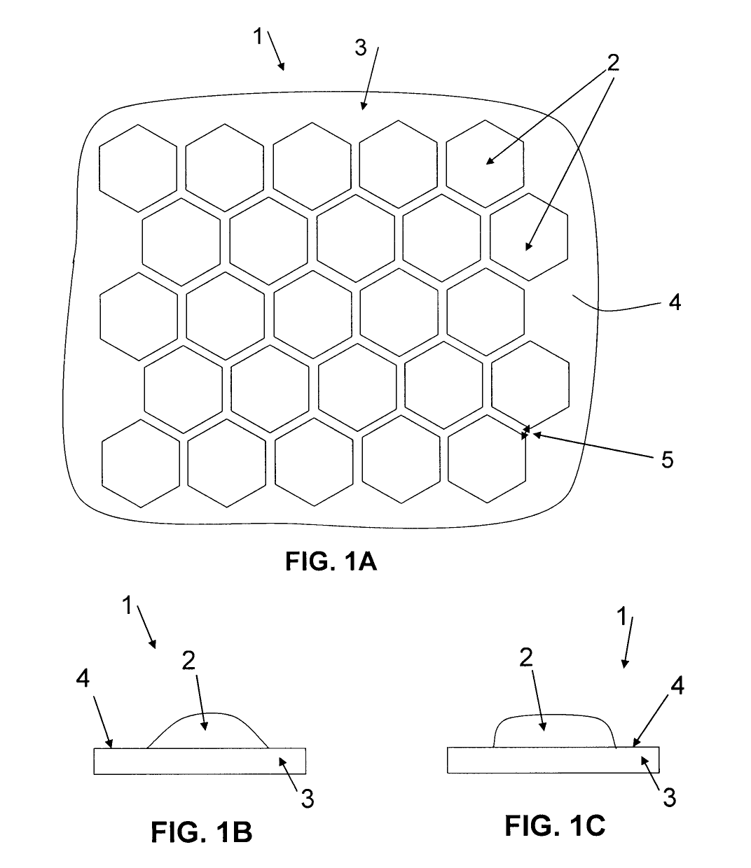

FIG. 1A shows a top plan view of a protective material 1 having a flexible substrate 3 and spaced-apart guard plates 2 according to one embodiment of the present invention. The guard plates 2 are affixed to a first or top surface 4 of the flexible substrate 3 in a spaced relationship to each other. In the embodiment illustrated in FIG. 1, the guard plates 2 are hexagonal in shape. In other embodiments, the guard plates 2 can have other shapes, e.g., oval, square, or any other polygon, and can be arranged in a random or irregular space-filling arrangement. The guard plates 2 have a gap width 5 between adjacent plates. In the embodiment illustrated in FIG. 1C, the vertical profile of the guard plates 2 is generally flat. In the embodiment illustrated in FIG. 1B, the vertical profile of the guard plates 2 has the form of a dome.

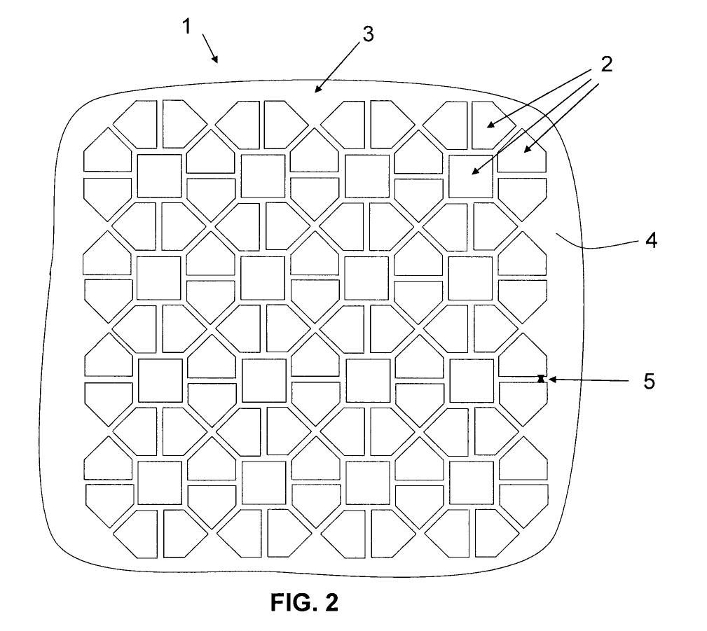

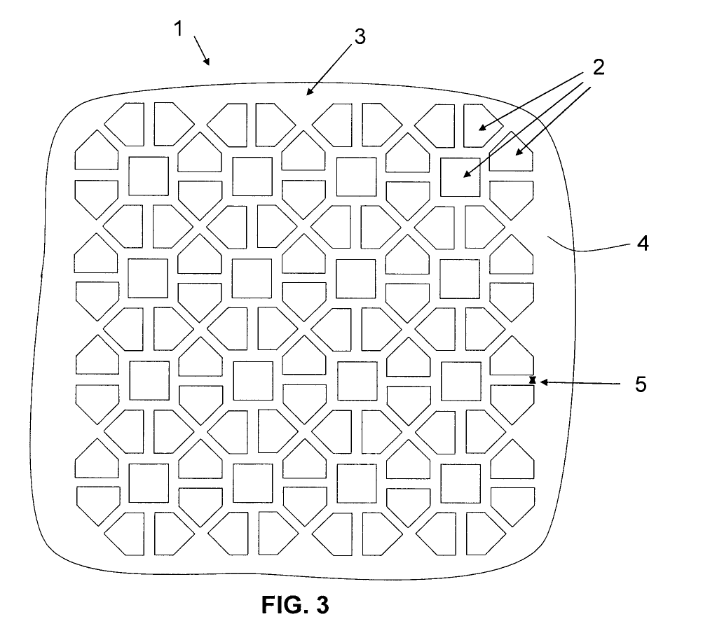

FIG. 2 shows an alternative embodiment where the guard plates 2 have the shapes of squares or pentagons. In one embodiment the size of the squares are between about 50 and about 150 mils across, while the gap width 5 is between about 5 and about 50 mils. FIG. 3 shows a similar arrangement of plates as FIG. 2, but with larger gap widths.

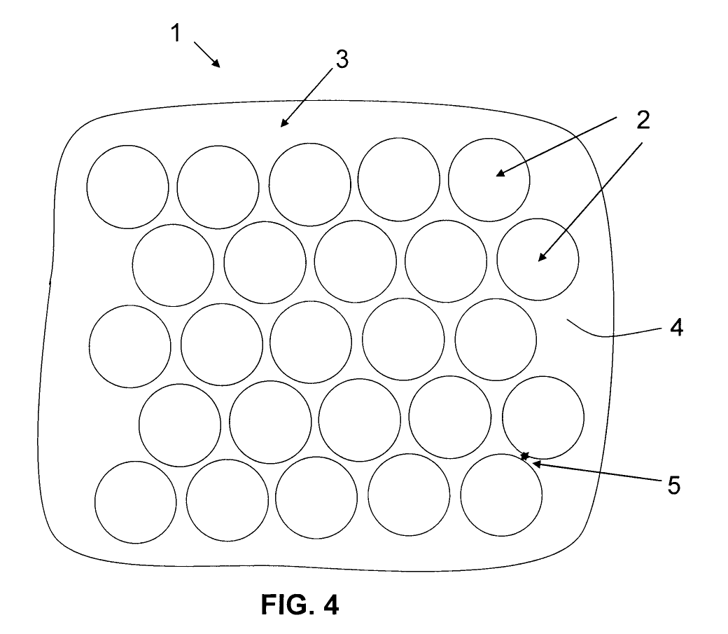

FIG. 4 shows an embodiment where the guard plates 2 are circular in shape. In one embodiment the diameter of the circles is between about 50 and about 150 mils and the gap width 5 is between about 5 and 150 mils.

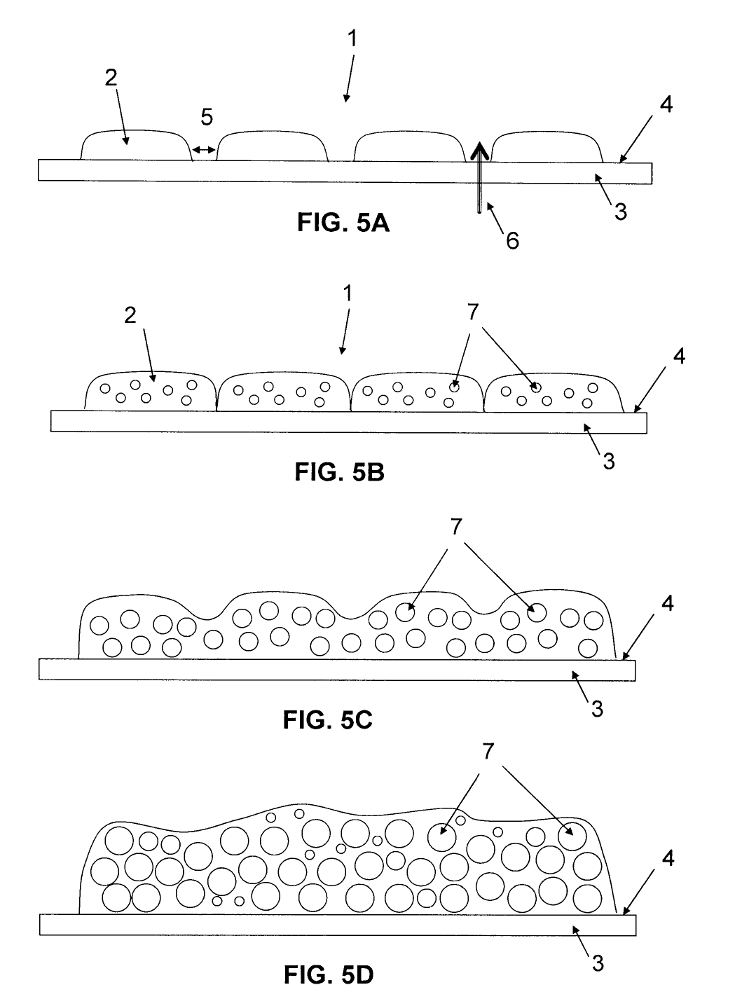

FIGS. 5A-5D shows examples of a protective material 1 in various stages of intumescing. FIG. 5A shows an example of a protective material 1 that has not intumesced. The gaps 5 between guard plates 2 in this case are open and allow for bulk air flow 6 through the protective material 1. FIG. 5B shows an example of a protective material 1 shortly after it has started to intumesce. The gaps 5 in this example have closed due to the expansion of an expansion agent 7. FIG. 5C shows the protective material 1 of FIG. 5B after additional heat has been applied and additional intumescence has occurred. FIG. 5D shows the protective material 1 of FIG. 5C after even further intumescence has occurred.

Various embodiments of the protective material and methods of manufacturing the protective material are described in commonly owned U.S. Pat. No. 6,962,739, titled SUPPLE PENETRATION RESISTANT FABRIC AND METHOD OF MAKING, filed Jul. 6, 2000, U.S. Pat. No. 7,018,692, entitled PENETRATION RESISTANT FABRIC WITH MULTIPLE LAYER GUARD PLATE ASSEMBLIES AND METHOD OF MAKING THE SAME, filed Dec. 21, 2001, U.S. Patent Application Publication No. 20040192133, entitled ABRASION AND HEAT RESISTANT FABRICS, Ser. No. 10/734,686, filed on Dec. 12, 2003, U.S. Patent Application Publication No. 20050170221, entitled SUPPLE PENETRATION RESISTANT FABRIC AND METHOD OF MAKING, Ser. No. 10/980,881, filed Nov. 3, 2004, and U.S. Patent Application Publication No. 20050009429, entitled FLAME RETARDANT AND CUT RESISTANT FABRIC, Ser. No. 10/887,005, filed Nov. 3, 2004, all herein incorporated by reference in their entirety.

In one embodiment, the flexible substrate is a polymer film. In another embodiment, the flexible substrate is a woven fabric. In another embodiment the flexible substrate is a knitted fabric. In yet another embodiment, the flexible substrate is a non-woven fabric. Other embodiments of the invention use other fabrics described in the commonly-assigned patents and patent publications identified above.

Commonly, the resin material of the guard plate is a resin selected for its cut, pierce, or puncture resistance, durability and/or bonding characteristics to the flexible substrate as well as its bonding characteristics to the substrate. One suitable material for the guard plate is a thermosetting epoxy resin. The gap width is selected in order to maintain flexibility of the flexible substrate, which permits the overall protective material to exhibit and preserve its properties of flexibility and suppleness. Another suitable material for the guard plate is a thermosetting silicone. Other embodiments of the invention use other guard plates and gaps described in the commonly-assigned patents and patent publications identified above.

The flexible substrate is typically also chosen to fulfill desired performance characteristics. For instance, the flexible substrate can comprise a single layer of fabric (woven or non-woven), or include multiple layers with varying physical characteristics in which the aforementioned layers are laminated or bonded to one another or just stacked in place and sewn around the borders in the final application. Typical desired physical considerations for the flexible substrate include tensile, burst and tear strength, flexibility/suppleness, water-proofness, air permeability, tactility, comfort, and inherent flammability. In certain applications, elasticity of the flexible substrate is also desired.

The guard plates may be affixed to the base fabric by means of a screen printing process, including those described in the commonly-assigned patents and patent publications identified above. By printing through an appropriately shaped screen, the guard plates can take many forms, including dots, hexagons, pentagons, squares, and many other shapes. The guard plates can range in size from tens of mils to hundreds of mils in width or length and a few mils to tens of mils in thickness. Distances between guard plates can also range from a few mils to tens of mils.

In one embodiment, the guard plates are constructed of a thermosetting material which can be cured through heat to a hardened state. The thermosetting material must be curable at temperatures below which the heat-expandable expansion agents begin to expand. At room temperature, the thermosetting material must be capable of being screen printed, that is, in a liquid state with appropriate viscosity, such that subsequent curing of the material yields guard plates of desired (e.g., uniform) shape and size with desired (e.g., uniform) distances of separation. To achieve this objective, appropriate rheological may be added to the uncured material, provided the target properties of the cured guard plates are unaffected.

In another embodiment, the guard plates may be constructed of a thermoplastic material. The material preferably has a melting temperature less than the temperature at which the heat-expandable expansion agents begin to expand. It preferably also has acceptable viscosity at such temperatures to facilitate incorporation of microspheres or other additives and screen printing of the material.

In another embodiment, the guard plates may be constructed of a UV-curable material.

The material used to construct the guard plates should be inherently flame resistant in order to provide adequate protection for the base fabric. In some embodiments, a material that is flammable in an unmodified state may be used when it is modified to be sufficiently flame resistant. Such modification can entail the incorporation of additional flame resistant additives, including, but not limited to, sodium silicate, expandable graphite, unexpanded vermiculite, alumina trihydrate, magnesium hydroxide, ammonium polyphosphate, monoammonium phosphate, melamine phosphate, melamine cyanurate, other melamine-based flame retardants, or other phosphorous-based flame retardants. In addition, the material should have sufficient elongation ability, so as to allow for expansion upon flame contact. Preferably, the material is also able to expand sufficiently to completely cover the portions of exposed base fabric.

In embodiments incorporating expandable microspheres, the guard plate material will preferably allow the incorporated microspheres to expand to their maximum limit and rupture. In this last case, a flame contacting the material will cause the microspheres to expand the guard plates to form an essentially continuous barrier protecting the underlying base fabric; this will be followed by the rupturing of the microspheres and the release of the encapsulated fluid.

The guard plate material can be chosen to have a low thermal conductivity to prevent heat transfer through the guard plates and melting of the base fabric. In embodiments where nylon or polyester or other fabrics that can melt when exposed to a flame is used, the low thermal conductivity property is for effective flame resistance because melting is the ultimate cause of failure of the fabric and therefore reduction of heat transfer from the flame to the base fabric directly corresponds to increased flame resistance. In embodiments utilizing microspheres, the expansion of the guard plates and the evaporation of the fluid encapsulated within the microspheres, however, intrinsically reduce the heat transfer to the base fabric.

In one embodiment the guard plate material comprises an epoxy. In other embodiments the guard plate material comprises an elastomer. Possible materials include silicones, polyurethanes, nitrile rubber, polybutadiene rubber, butyl rubber, polychloroprene rubber, ethylene propylene rubber, chlorosulfonated rubber, polyethylene, ethylene alkyl acetates, ethylene alkyl acrylates, and polypropylene. The latter thermoplastic materials are generally less desirable due to their flammability. Thus, additional flame resistant additives would likely need to be incorporated into the guard plates if a thermoplastic material is used.

There are a number of techniques that could be used to create water-encapsulating microspheres that could be used as the expansion agent in the present invention. For example, the interfacial polymerization technique could be used, where a water-in-oil emulsion containing a water-soluble monomer is mixed with another water-in-oil emulsion containing water-soluble polymerization agents, causing polymerization to a water-insoluble material that encapsulates the emulsified water droplets. Further details of this technique are given in “Microencapsulation of Water-Soluble Herbicide by Interfacial Reaction. I. Characterization of Microencapsulation,” Journal of Applied Polymer Science, Vol. 78, pp. 1645-1655. Many slight variations of this technique, for example the use of initially oil-soluble monomers, exist and are suitable for microencapsulation of water. Other possible techniques involve the use of a water-in-oil emulsion containing an oil-soluble or water-soluble polymer which is caused to precipitate out to the water-oil interface. This could be accomplished by liquid-liquid extraction or evaporation of the polymer solvent, in the case of an oil-soluble polymer, or by altering the polymer solvent, for example by adjusting the pH, to reduce the solubility of the polymer, in the case of both oil- and water-soluble polymers. An example of such a technique is given in U.S. Pat. No. 6,638,984.

The beginning expansion temperature of the water-encapsulating microspheres will be about 100° C. However, this temperature can easily be raised through the addition of a salt such as calcium chloride. Other requirements of the preferred material constituting the shells of the microspheres are water-insolubility and a glass transition temperature below 100° C. or below the raised boiling point of water, if applicable. For the purpose of screen printing the guard plate material onto the base fabric, it is desirable that the microspheres have a diameter no greater than 250 microns. More preferably, the microspheres should have a diameter no greater than 100 microns. The microspheres, guard plate material, and any other additives, such as additional flame retardants, pigments, rheological modifiers, or wetting or dispersion agents, are to be mixed, screen printed onto the base fabric in a desired shape and design, and cured to a hardened state, if necessary.

In an alternative embodiment, two or more intumescing mechanisms are incorporated into the design. For example, a catalyst such as ammonium polyphosphate with a blowing agent such as melamine can be used in conjunction with expandable microspheres. This will allow two separate activation temperatures to be realized with the lower temperature mechanism initiating early to provide thermal protection against the initial thermal threat and the higher temperature mechanism providing protection against continued heating. These multiple intumescing mechanisms can be incorporated in a single layer of guard plates or there can be multiple printings of two or more layers of guard plates with each layer having a different intumescing mechanism.

In one embodiment, the intumescent mechanism is activated between about 50 C and about 300 C. In another embodiment there are two or more intumescent mechanisms with one activating between about 50 C and about 150 C and another activating between about 100 C and about 300 C.

When the guard plates have been affixed to the base fabric, the resulting fabric is breathable and flexible and the mechanical strength of the base fabric is uncompromised. Furthermore, the guard plate material can afford increased durability and abrasion resistance, slash resistance, and/or grip to the base fabric. If the fabric contacts a flame, the guard plates will be expanded by the incorporated expansion agent to form an essentially continuous layer protecting and insulating the base fabric. In embodiments where the expansion agent comprises expandable microspheres, rupturing of the microspheres can further protect the base fabric due to the release of the core fluid. These combined properties make the fabric of the present invention especially suitable for fire resistant apparel, although any application requiring a fire resistant or thermal insulating textile material may be suitable.

If additional slash or puncture resistance is desirable for a certain application, guard plates intended to enhance such properties can be affixed either to the base fabric or to the fire resistant guard plates. Also, multiple layers can be used. In particular, one or more layers of standard non-intumescing SuperFabric® can be used as backing layers to improve the overall slash, puncture or other mechanical properties. The outer intumescing layer will largely protect the inner SuperFabric® layers from flame and heat.

To achieve enhanced thermal protection, a second layer of SuperFabric® can be used behind the intumescing SuperFabric® layer. This second layer of SuperFabric® can utilize guard plates made of a low thermal conductivity material. Using well spaced plates will trap more air between the two layers, minimizing physical contact between the layers and lowering the overall thermal conductivity. In one embodiment, the guard plates of the second layer comprise epoxy filled with hollow glass beads. The guard plate shape and the gaps between guard plates can be chosen to maximize the thermal insulation property and to maximize flexibility. In one embodiment, guard plates approximately 700 microns in height and 2500 microns in width are used with gaps of approximately 500 microns. In another embodiment the guard plates are 200-700 microns in height and 1000-2500 microns in width and the gaps are 100-500 microns. In one embodiment the guard plates cover between 20 and 95 percent of the surface of the substrate. In another embodiment the guard plates cover 40 to 80 percent of the surface of the substrate. In other embodiments, more that two layers can be used to further improve thermal protection properties or to add additional properties such as cut resistance.

The present invention is a unique approach for providing an intumescent system on a fabric to produce flame and/or heat resistant fabric. In particular, guard plates that have the ability to intumesce when sufficient heat is applied are affixed to a flexible substrate. When heat is applied the guard plates swell in size to a sufficient extent that the gaps between the guard plates are effectively closed. The resulting intumesced structure provides an excellent thermal barrier. In embodiments where the flexible substrate is flammable, the intumesced guard plates will block the flame from reaching the fabric surface thus imparting flame resistance to the overall structure.

We claim:

1. A protective material comprising:
a flexible substrate including a surface; and
a plurality of discrete guard plates affixed to the surface in a spaced relationship to each other, wherein the guard plates comprise a material which significantly expands upon the addition of sufficient heat.

2. The protective material of claim 1 wherein the flexible substrate is a woven, knitted, or non-woven fabric and wherein the guard plates partially penetrate the surface of the fabric.

3. The protective material of claim 1 wherein the flexible substrate is a polymer film.

4. The protective material of claim 1 wherein the guard plates cover 40%-80% of the substrate.

5. The protective material of claim 1 wherein guard plates have a major diameter between about 1000 and 2500 microns and the guard plates are spaced apart by gaps between about 100 and 500 microns.

6. The protective material of claim 1 wherein the expansion of the guard plate is activated at temperatures between about 50 C and about 300 C.

7. The protective material of claim 1 wherein the expansion of the guard plate occurs in two or more stages and wherein one stage is activated at temperatures between about 50 C and about 150 C and another stage is activated at temperatures between about 100 C and about 300 C.

8. The protective material of claim 1, wherein the guard plate material comprises a resin and an expansion agent.

9. The protective material of claim 8, wherein the expansion agent includes liquid droplets in the resin.

10. The protective material of claim 8, wherein the guard plate material includes a thermoset resin.

11. The protective material of claim 8, wherein the guard plate material includes a thermoplastic resin.

12. The protective material of claim 8, wherein the guard plate material further comprises flame retardant additives.

13. The protective material of claim 12, wherein the additional flame retardant additives comprise one or more of the following: aluminum trihydrate, magnesium hydroxide, antimony trioxide, zinc borate, brominated compounds, chlorinated compounds, monoammonium phosphate, melamine salts, melamine-based compounds, ammonium polyphosphate, pentaerythritol, sodium silicate, vermiculite, and expandable graphite.

14. The protective material of claim 8, wherein the expansion agent includes thermally expandable microspheres.

15. The protective material of claim 14, wherein the thermally expandable microspheres comprise a non-flammable liquid surrounded by a polymeric shell.

16. The protective material of claim 15, wherein the non-flammable liquid comprises water and the polymeric shell comprises a material with a glass transition temperature less than 100° C.

17. The protective material of claim 15, wherein the non-flammable liquid comprises water and a compound that raises the vaporization temperature of the water, and the polymeric shell comprises a material with a glass transition temperature less than the vaporization temperature.

18. The protective material of claim 1, wherein the expansion of the guard plates fills the gaps between adjacent guard plates to form a continuous protective layer.

19. The protective material of claim 1, wherein the expansion of the guard plates is activated at temperatures greater than about 50 C.

20. The protective material of claim 1, wherein the guard plate material expansion occurs in at least first and second stages, wherein the first stage is activated at a temperature greater than a first temperature, and the second stage is activated at a temperature greater than a second temperature, and wherein the second temperature is greater than the first temperature.

21. The protective material of claim 1, wherein the guard plates have major and minor diameters and wherein the major diameter to minor diameter aspect ratio is between about 1 and about 3.

22. A protective material comprising:
a first layer including a flexible substrate including a surface and a plurality of discrete guard plates affixed to the surface in a spaced relationship to each other, wherein the guard plates comprise a material which significantly expands upon the addition of sufficient heat; and
a second layer including a flexible substrate including a surface and a plurality of discrete guard plates affixed to the surface in a spaced relationship to each other, wherein the guard plates comprise a low-thermal conductivity material.
